(19) United States
(12) Patent Application Publication
(10) Pub. No.: US 2025/0184660 A1
(43) Pub. Date: Jun. 5, 2025

(54) EARCUP FOR AUDIO COMMUNICATION AND HEADSET

(71) Applicant: FalCom A/S, Ballerup (DK)

(72) Inventor: Lars Ivar HAUSCHULTZ, Vanløse (DK)

(73) Assignee: FalCom A/S, Ballerup (DK)

(21) Appl. No.: 18/966,104

(22) Filed: Dec. 2, 2024

(30) Foreign Application Priority Data
Dec. 5, 2023 (EP) 23214176.2

(51) Int. Cl. H04R 1/28; H04R 1/02; H04R 1/10; H04R 1/44

(52) U.S. Cl. CPC H04R 1/2888; H04R 1/023; H04R 1/1008; H04R 1/1041; H04R 1/1083; H04R 1/44; H04R 2201/107; H04R 2460/01; H04R 2460/11

(57) ABSTRACT

The earcup comprises a housing wall separating an inner cavity inside the earcup from space surrounding the earcup, and an electroacoustic transducer with a diaphragm. The diaphragm is configured to emit sound into the surrounding space from a front side of the diaphragm. A gas in the inner cavity has a first pressure that exerts a force on the back side of the diaphragm. The earcup further comprises a displaceable wall that fluidly divides the inner cavity into a first sub-cavity containing the gas and a second sub-cavity containing one or more fluids, and one or more openings in the housing wall that fluidly connect the second sub-cavity with the surrounding space. The displaceable wall is configured to be displaced by oppositely directed forces exerted respectively by the first pressure and by a second pressure of the one or more fluids.

### RELATED APPLICATION DATA

This application claims priority to, and the benefit of, European Patent Application No. 23214176.2 filed on Dec. 5, 2023. The entire disclosure of the above application is expressly incorporated by reference herein.

### FIELD

The present disclosure relates to an earcup for audio communication, e.g. for use in headsets and other wearable audio communication devices and systems. The disclosure further relates to a headset comprising one or two such earcups. One or more embodiments described herein may e.g. be used to enable divers and/or skydivers to wear their headsets respectively under water and at high altitudes above ground without risking a collapse of the earcup.

### BACKGROUND

An earcup for a headset typically comprises a loudspeaker with an actively driven diaphragm that produces sound for the user wearing the headset. Such an earcup may further be equipped with an active noise canceller (ANC) that causes the loudspeaker to emit an anti-noise sound that ideally cancels ambient noise that passes through or past the earcup into the user's ear. It is well known that such earcups may be configured with an air-tight inner cavity behind the diaphragm to reduce the level of noise reaching the user's ear through the earcup and thus both make the job for the ANC system easier and reduce some of the noise that the ANC system cannot handle.

When a diver or skydiver wears an earcup with an air-tight inner cavity, their vertical movement will cause a change of the pressure in the water or air that surrounds the earcup and thus cause a pressure difference between the inner cavity and its surroundings. This pressure difference may, depending on the change of diving depth or altitude, cause damage to the loudspeaker, to its diaphragm and/or to the housing structure of the earcup. While, essentially, such components of the earcup may be configured in a more robust manner, this typically comes at a cost of heavier earcup and/or lower sound quality, and is typically only possible for minor pressure changes, such as less than 10%. For many professional or sports users of headsets, such limitations are not acceptable. In addition, the back side of the loudspeaker and/or its diaphragm which are typically exposed to the inner cavity should normally be kept dry to avoid corrosion and other negative effects from ingress of water.

There is thus a need for alternative solutions that allow for wearing or using earcups at varying diving depths and/or altitudes above ground without the disadvantages of prior art earcups.

### SUMMARY

It is an object to provide an earcup for audio communication. It is a further object to provide a headset with one or two earcups for audio communication.

In accordance with some embodiments, the earcup comprises a housing wall that is configured to separate an inner cavity inside the earcup from space surrounding the earcup, and an electroacoustic transducer with an actively driven diaphragm arranged in or across an opening in the housing wall and/or as a portion of the housing wall. The electroacoustic transducer is configured to cause the diaphragm to emit sound into the surrounding space from a front side of the diaphragm. A gas in the inner cavity has a first pressure that exerts a force on the back side of the diaphragm.

The earcup further comprises a displaceable wall that fluidly divides the inner cavity into a first sub-cavity containing the gas and a second sub-cavity containing one or more fluids, and one or more openings in the housing wall that fluidly connect the second sub-cavity with the surrounding space. The displaceable wall is configured to be displaced by oppositely directed forces exerted respectively by the first pressure and by a second pressure of the one or more fluids and thus change the volume of the first sub-cavity in reaction to a change in the difference between the first pressure and the second pressure, thereby reducing a pressure difference between the front side and the back side of the diaphragm.

One or more embodiments described herein may e.g. be used to enable divers and/or skydivers to wear their headsets respectively under water and at high altitudes above ground without risking a collapse of the earcup.

The above objects and other objects are achieved by embodiments described in the detailed description.

### DESCRIPTION OF THE DRAWINGS

The embodiments will be explained in more detail below with reference to the drawings in which:

FIG. 1 shows an embodiment of an earcup,

FIG. 2 shows alternative embodiments of parts of the earcup of FIG. 1,

FIG. 3 shows further details of the earcup of FIG. 1,

FIG. 4 shows further details of the earcup of FIG. 1,

FIG. 5 shows further details of the earcup of FIG. 1, and

FIG. 6 shows an embodiment of a headset.

The figures are schematic and simplified for clarity. Where practical, like reference numerals and/or labels are used for identical or corresponding parts.

### DESCRIPTION OF THE EMBODIMENTS

Various embodiments are described hereinafter with reference to the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

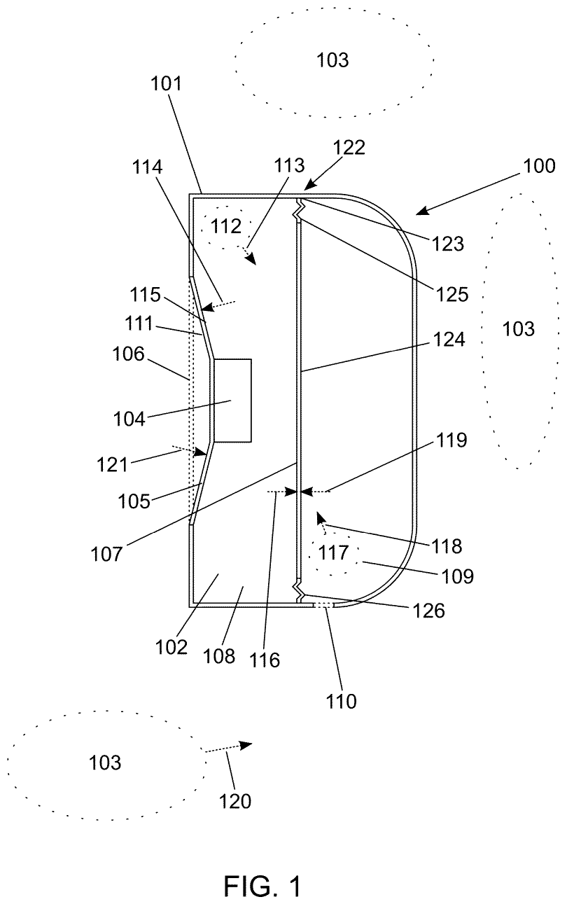

The example earcup 100 shown in FIG. 1 comprises a housing wall 101 that separates an inner cavity 102 inside the earcup from space 103 surrounding the earcup, an electroacoustic transducer 104 with an actively driven diaphragm 105 arranged in a first opening 106 in the housing wall 101, a displaceable wall 107 that fluidly divides the inner cavity 102 into a first sub-cavity 108 and a second sub-cavity 109, and one or more second openings 110 in the housing wall 101 that fluidly connect the second sub-cavity 109 with the surrounding space 103. In the following, the side of the displaceable wall 107 that faces the first sub-cavity 108 is referred to as the “dry side”, and the opposite side of the displaceable wall 107 that faces the second sub-cavity 109 is referred to as the “wet side”. Where in the following a “side” or “sides” of the displaceable wall 107 is mentioned, these terms refer to its dry and/or wet sides. When in use, the electroacoustic transducer 104 causes the diaphragm 105 to emit sound into the surrounding space 103 from a front side 111 of the diaphragm. A gas 112, such as air, in the first sub-cavity 108 of the inner cavity 102 has a first pressure 113 that exerts a first force 114 on the back side 115 of the diaphragm 105 and a second force 116 on the dry side of the displaceable wall 107. One or more fluids 117, such as air or water or a mixture hereof, in the second sub-cavity 109 have a second pressure 118 that exerts a third force 119 on the wet side of the displaceable wall 107.

The displaceable wall 107 is configured such that the oppositely directed forces 116, 119 acting on it cause it to be displaced and thus change the volume of the first sub-cavity 108 when the difference between the first pressure 113 and the second pressure 118 changes. The change of the volume of the first sub-cavity 108 causes a change in the first pressure 113 of the gas 112 therein. Ideally, the one or more second openings 110 cause the second pressure 118 to equal the ambient pressure 120 (i.e. the pressure in the surrounding space 103) which exerts a fourth force 121 on the front side 111 of the diaphragm 105, and the displacement continues until an equilibrium is reached wherein the first pressure 113 and the second pressure 118 are equal, such that the pressure difference between the front side 111 and the back side 115 of the diaphragm 105 is zero. Depending on the configuration of the earcup 100 and/or the pressure difference, mechanical components of the ear cup may exert further forces on each other which may cause the first pressure 113 and the second pressure 118 to differ from each other at the equilibrium.

The first sub-cavity 108 may essentially function as an air-tight inner cavity behind the diaphragm 103 that helps reducing the level of noise reaching a user's ear through the earcup 100, while the displaceable wall 107 and the one or more second openings 110 function as a pressure equalization device that automatically reduces pressure differences between the front side 111 and the back side 115 of the diaphragm 105.

For instance, when a diver takes the earcup 100 from surface level down to a depth of 10 m below the surface, the ambient pressure 120 increases from 1 atm (appr. 100 kPa) to about 2 atm. The pressure increase causes water 117 to enter the second sub-cavity 109 through the one or more second openings 110, thereby increasing the second pressure 118 on the displaceable wall 107 such that the displaceable wall 107 is displaced (leftwards in the fig.), thereby reducing the volume of the first sub-cavity 108 until an equilibrium is reached when the volume of the first sub-cavity 108 is about half its size at surface level and, correspondingly, the first pressure 113 is increased from 1 atm to about 2 atm. On the diver's way back to the surface level, these changes are reversed. During the diving, the first sub-cavity 108 remains dry so that the back side of the loudspeaker is protected against ingress of water 117.

Similarly, when a skydiver takes the earcup 100 from ground level (here assumed to be close to sea level) up to an altitude of 5,500 m above ground level, the ambient pressure 120 decreases from 1 atm to about 0.5 atm. The pressure decrease causes air 117 to exit the second sub-cavity 109 through the one or more second openings 110, thereby decreasing the second pressure 118 on the displaceable wall 107 such that the displaceable wall 107 is displaced (rightwards in the fig.), thereby increasing the volume of the first sub-cavity 108 until an equilibrium is reached when the volume of the first sub-cavity 108 is about double its size at ground level and, correspondingly, the first pressure 113 is decreased from 1 atm to about 0.5 atm. On the skydiver's way back to ground level, these changes are reversed.

In both cases described above, the ratio between the maximum and the minimum volume of the first sub-cavity 108 obtained by the displacement of the displaceable wall 107 is about 2. Depending on the intended use of the earcup 100, it may be configured to be able to obtain a smaller or larger ratio, such as about or at least 1.2, about or at least 1.5, about or at least 2, about or at least 3, or about or at least 4. For instance, if an earcup is intended for use by skydivers who also dive, a ratio of 4 would be needed to accommodate for both cases described above without requiring intermediate adjustments of the first pressure 113 by other means than displacement of the displaceable wall 107. The earcup 100 may be configured to be able to obtain even larger ratios to enable further displacement caused by pressure changes due to changes in temperature.

The embodiment of the displaceable wall 107 shown in FIG. 1 is generally disc-shaped and is attached along its periphery 122 to a portion 123 of the inner side of the housing wall 101. The displaceable wall 107 comprises a rigid center plate 124 peripherally attached to a stretchable and/or pliable suspension 125 that connects the center plate 124 to the portion 123 of the inner side of the housing wall 101 and thereby enables the center plate 124 to move towards or away from the diaphragm 105 of the electroacoustic transducer 104, much like speaker surrounds that are generally used to enable speaker diaphragms or speaker cones to move axially. The suspension 125 may comprise one or more circular concentric ripples 126 that enable larger axial movements of the center plate 124. In other embodiments, the center plate 124 may be integral with, or made from the same material as, the suspension 125. In any embodiment, the center plate 124 may have a larger thickness than the suspension 125. In some embodiments, the center plate 124 may be stretchable and/or pliable to the same degree, or to a lesser degree, than the suspension 125.

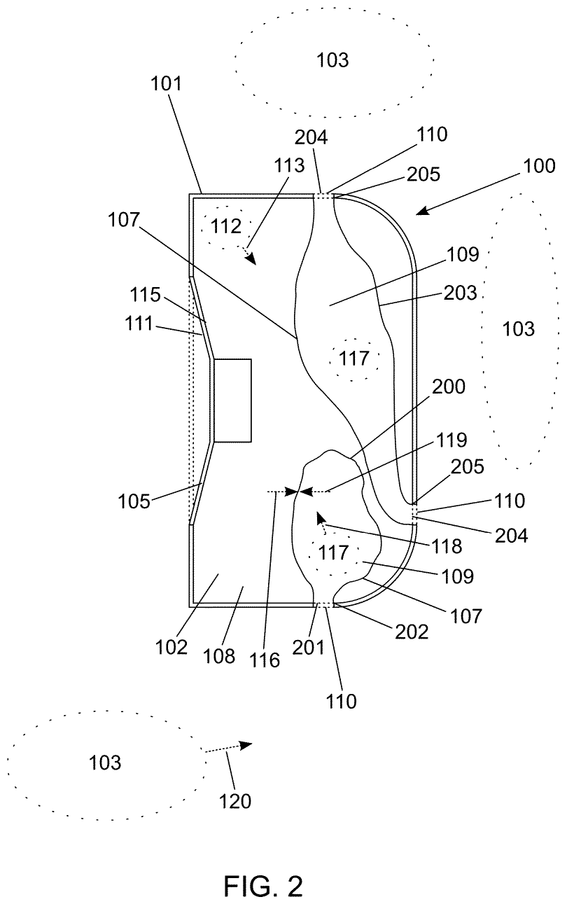

In FIG. 2, the example earcup 100 is shown with two further possible embodiments of the displaceable wall 107. In the first embodiment, the displaceable wall 107 is configured as a stretchable and/or pliable bladder 200 attached at its single bladder opening 201 to a portion 202 of the inner side of the housing wall 101 that surrounds the one or more second openings 110. In the second embodiment, the displaceable wall 107 is configured as a stretchable and/or pliable tubular bladder structure 203 attached at its two bladder openings 204 to respective portions 205 of the inner side of the housing wall 101 that surround different subsets of the one or more second openings 110. The tubular bladder structure 203 may be attached at more than two bladder openings 204, such as three, four or more, to respective portions 205 of the inner side of the housing wall 101 that surround different subsets of the one or more second openings 110, whereby the displaceable wall 107 would be configured like a manifold structure. Each of the said subsets of the one or more second openings 110 may comprise one or more of the one or more second openings 110, and none of the one or more second openings 110 may be comprised by more than one such subset.

At one extreme, the displaceable wall 107 may be attached to the inner side of the housing wall 101 along a line that always circumscribes the entire displaceable wall 107. In FIG. 1, such a line would follow the portion 123 of the inner side of the housing wall 101. At an opposite extreme, the displaceable wall 107 may be attached to the inner side of the housing wall 101 along a line that narrowly circumscribes the one or more second openings 110, a subset of the one or more second openings 110, or only one of the one or more second openings 110. In FIG. 2, such a line would extend along the portion 202 of the inner side of the housing wall 101 to which the bladder 200 is attached. The displaceable wall 107 may be attached to other, intermediate, portions of the housing wall 101, given that such attachment still ensures that the displaceable wall 107 fluidly divides the inner cavity 102 into a first sub-cavity 108 and a second sub-cavity 109. Accordingly, the location, shape and/or size of the displaceable wall 107, as well as the location, shape and/or size of a periphery 122 of a disc-shaped displaceable wall 107 and/or of an opening 201 of a bladder 200, 203, may deviate from the examples shown herein. In any embodiment, the displaceable wall 107 should be attached to the inner side of the housing wall 101 in a manner that ensures that the back side 115 of the diaphragm 105 is facing the first sub-cavity 108 and does not face the second sub-cavity 109. In other words, the back side 115 of the diaphragm 105 should be exposed to the gas 112 in the first sub-cavity 108 and should not be exposed to the one or more fluids 117 in the second sub-cavity 109.

In any embodiment, the earcup 100 may comprise multiple displaceable walls 107, wherein each displaceable wall 107 is configured e.g. as a disc-shaped displaceable wall 107, as a bladder 200, as a tubular bladder structure 203, as a manifold structure, and/or with an intermediate shape. Accordingly, the earcup 100 may comprise multiple respective second sub-cavities 109, each fluidly separated from the first sub-cavity 108 by a respective one of the multiple displaceable walls 107.

In any embodiment, each displaceable wall 107 may, at least partly, be made from a stretchable and/or pliable material, such as rubber, fabric, foam, or latex, or from a combination of such materials. Any portions made from such stretchy and/or pliable materials may be made thin to reduce the force needed to change their shape. The displaceable wall 107 may comprise wall portions that are more stretchable and/or pliable than other portions of the displaceable wall 107.

In any embodiment, multiple second openings 110 may fluidly connect a common second sub-cavity 109 with the surrounding space 103, such that a user may be able to cleanse the second sub-cavity 109 by pressing water or air into the second sub-cavity 109 through one of the multiple openings 110 and let it escape through one or more other of the multiple openings 110.

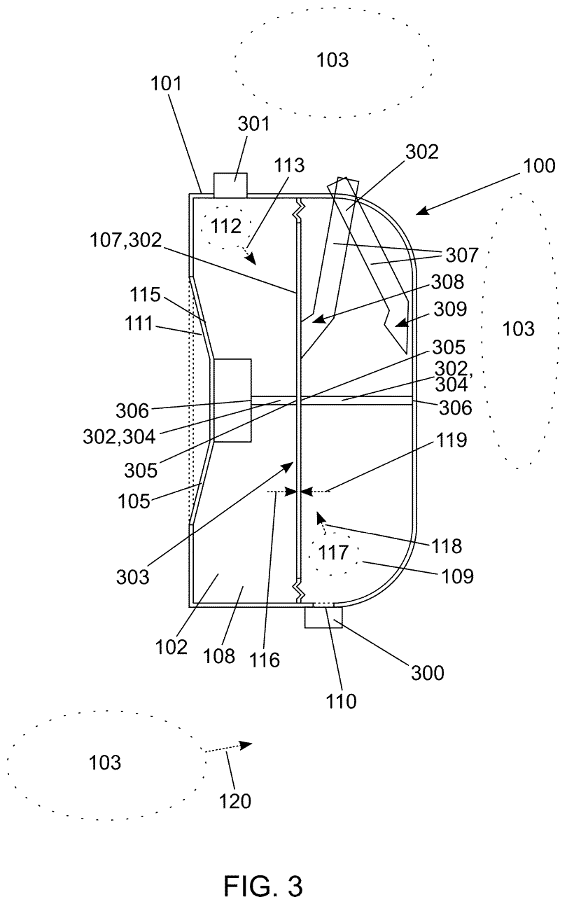

As shown in FIG. 3, the earcup 100 may further comprise a flow control device 300 that can be controlled into a first mode wherein it enables flow of the one or more fluids 117 through the one or more second openings 110 and into a second mode wherein it, relative to its first mode, reduces or prevents flow of the one or more second fluids 117 through the one or more second openings 110, at least in the direction into the second sub-cavity 109. The second mode may comprise multiple sub-modes, such as a sub-mode wherein the flow control device 300 reduces flow in both directions, a sub-mode wherein the flow control device 300 prevents flow in both directions, a sub-mode wherein the flow control device 300 reduces or prevents flow only in one direction, a sub-mode wherein the flow control device 300 prevents or reduces flow into the second sub-cavity 109 and does not reduce or prevent flow out of the second sub-cavity 109, and/or a sub-mode wherein the flow control device 300 prevents flow into the second sub-cavity 109 and reduces flow out of the second sub-cavity 109.

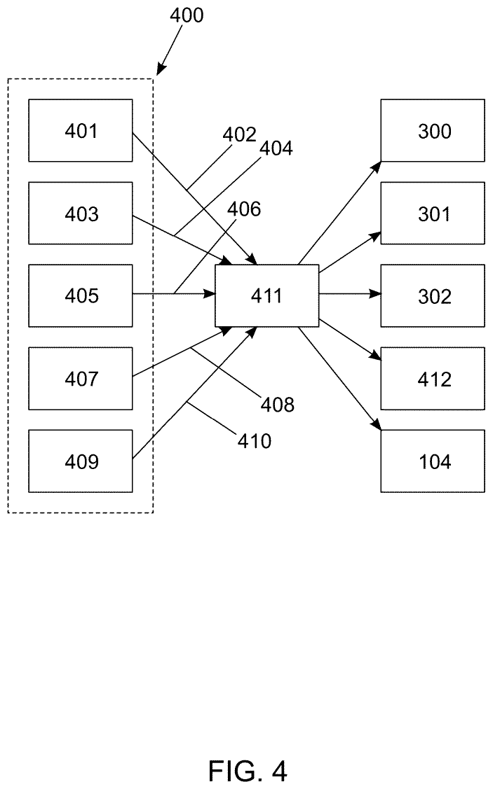

The flow control device 300 may be configured to be selectively manipulatable into its first or its second mode, and/or a sub-mode hereof, by a user of the earcup. Alternatively, or additionally, the flow control device 300 may comprise one or more actuators (not shown) that enable a control unit (411, see FIG. 4) to control its mode and/or a sub-mode hereof.

A user may manipulate or otherwise control the flow control device 300 into its first mode before beginning a dive or before entering an airplane from which they intend to skydive, such that the displaceable wall 107 may be displaced by the first pressure 113 and the second pressure 118 to reduce a pressure difference between the front side 111 and the back side 115 of the diaphragm 105. After finishing the dive or skydive, the user may manipulate or otherwise control the flow control device 300 into its second mode to reduce the amount of sound entering the second sub-cavity 109 from the surrounding space 103 and thereby increase the noise reduction provided by the earcup 100.

When the earcup 100 is configured for underwater use, at least one of the one or more second openings 110 is preferably arranged at the bottom of the housing wall 101 to enable most or all water 117 in the second sub-cavity 109 to exit when the user of the earcup 100 is wearing the earcup 100 in an intended listening position at or on one of their ears and with their head upright. In the following, the earcup 100 is said to be in its “intended listening orientation” when and only when the earcup 100 is oriented in the same way with respect to a horizontal plane as when the user is wearing the earcup 100 in this manner. Correspondingly, the term “bottom of the housing wall” herein refers to the vertically lower portion of the housing wall 101 when the earcup 100 is in its intended listening orientation.

The earcup 100 may comprise multiple flow control devices 300 as described above and operating on different subsets of the one or more second openings 110. A flow control device 300 that controls flow through a second opening 110 that is arranged at the bottom of the housing wall 101 preferably has a second mode, and/or a sub-mode hereof, wherein it does not reduce or prevent flow out of the second sub-cavity 109. In this case, the user may, after manipulating or otherwise controlling the flow control device 300 into such a sub-mode of its second mode and subsequently observing that all or most water has exited the second sub-cavity 109, manipulate or otherwise control the flow control device 300 into another sub-mode of its second mode wherein flow is further restricted or prevented to further reduce the amount of sound entering the second sub-cavity 109 from the surrounding space 103 and thereby further increase the noise reduction provided by the earcup 100.

As also shown in FIG. 3, the earcup 100 may further comprise a first valve 301 that can be controlled into a first mode wherein the first sub-cavity 108 and the surrounding space 103 are fluidly disconnected and into a second mode wherein the first sub-cavity 108 and the surrounding space 103 are fluidly connected to enable an at least partial equalization of the first pressure 113 and an ambient pressure 120.

The first valve 301 may be configured to be selectively manipulatable into its first or its second mode by a user of the earcup. Alternatively, or additionally, the first valve 301 may comprise one or more actuators (not shown) that enable a control unit 411 to control its mode.

A user may manipulate or otherwise control the first valve 301 to relieve an over- or under-pressure in the first sub-cavity 108 that may be caused by air exiting or entering the first sub-cavity 108 through diffusion and/or be caused by changes in the ambient pressure 120 due to a weather change and/or the user changing their location and/or altitude on ground. Such pressure relief should preferably be executed at ground level, above water, and immediately before an intended diving or skydiving to ensure that the displaceable wall 107 can adapt to the pressure changes that may subsequently occur during that diving or skydiving.

During diving, the first valve 301 should normally be controlled into its first mode to prevent water from entering the first sub-cavity 108, since residual water in the first sub-cavity 108 may negatively affect the performance of the electroacoustic transducer 104 and/or cause corrosion etc., e.g. if the water does not completely exit the first sub-cavity 108 after the user is out of the water again.

During altitude changes above sea, however, a user may manipulate or otherwise control the first valve 301 into its second mode to enable air 117 to enter or exit the first sub-cavity 108. In this case, and if the one or more second openings 110 are also open to flow, the pressure difference between the front side 111 and the back side 115 of the diaphragm 105 may be reduced even without a displacement of the displaceable wall 107, since both the first sub-cavity 108 and the second sub-cavity 109 will attain the same pressure as the ambient pressure 120. If, on the other hand, the one or more second openings 110 are not open to flow, then the displaceable wall 107 will be displaced by the first pressure 113 and the second pressure 119 albeit in the opposite direction as in the skydiving example explained further above.

As also shown in FIG. 3, the earcup 100 may further comprise a restriction device 302 that urges the displaceable wall 107 towards a default wall position 303 and/or restricts the displaceable wall 107 in the default wall position 303. The restriction device 302 preferably causes the displaceable wall 107 to attain the default wall position 303 when the first pressure 113 equals the second pressure 118.

The restriction device 302 may be configured such that it can be controlled into a first mode wherein it urges and/or restricts the displaceable wall 107 towards/in the default wall position 303 and into a second mode wherein it does not urge and/or restrict the displaceable wall 107 towards/in the default wall position 303. Such a restriction device 302 may be configured to be selectively manipulatable into its first or its second mode by a user of the earcup 100. Alternatively, or additionally, the restriction device 302 may comprise one or more actuators (not shown) that enable a control unit 411 to control it into its first or its second mode.

A user may manipulate or otherwise control the restriction device 302 into its first mode and thus urge and/or restrict the displaceable wall 107 towards/in the default wall position 303 before, while, or after manipulating or otherwise controlling the first valve 301 into its second mode to enable air to enter or exit the first sub-cavity 108 and then, when the difference between the first pressure 113 and the second pressure 118 has been sufficiently reduced by air entering or exiting the first sub-cavity 108, first manipulate or otherwise control the first valve 301 into its first mode to prevent flow of air into or out of the first sub-cavity 108 and subsequently manipulate or otherwise control the restriction device 302 into its second mode wherein it does not urge and/or restrict the displaceable wall 107 towards/in the default wall position 303. In this way, the user may easily restore the displaceable wall 107 to its default wall position 303, for instance before an intended diving or skydiving, such that the displaceable wall 107 is in an initial position from which it can adapt to the pressure changes that may subsequently occur during that diving or skydiving.

In the embodiment shown in FIG. 3, the restriction device 302 comprises two elastic components 304, such as springs, rubber bands, or the like, that each at one end or edge 305 are attached to opposite sides of the displaceable wall 107 and at a respective opposite end or edge 306 are attached to another part of the earcup 100. The restriction device 302 may comprise more than two elastic components 304. The elastic components 304 are preferably dimensioned and arranged such that they together urge the displaceable wall 107 towards the default wall position 303, while still allowing pressure changes to sufficiently displace the displaceable wall 107.

Alternatively, or additionally, the displaceable wall 107 may comprise one or more portions made of elastic material, such as rubber or the like, so that the displaceable wall 107 urges itself towards the default wall position 303, while still allowing pressure changes to sufficiently displace the displaceable wall 107. In some embodiments, the entire displaceable wall 107 may be made from such elastic material. In such embodiments, the displaceable wall 107 may itself act as a restriction device 302.

Alternatively, or additionally, the restriction device 302 may comprise a movable backstop 307 that in the first mode of the restriction device 302 is in a first position 308 wherein it abuts one side of the displaceable wall 107 and in the second mode of the restriction device 302 is in a second position 309 wherein it is distant from the displaceable wall 107 and thereby allows the displaceable wall 107 to move towards the movable backstop 307. In its first position 308, the movable backstop 307 may abut the displaceable wall 107 at one location, at multiple distinct locations and/or at a larger portion of the respective side of the displaceable wall 107.

A movable backstop 307 that is manipulatable by the user is preferably arranged at the portion of the earcup 100 that faces the wet side of the displaceable wall 107, such as in the second sub-cavity 109, since this reduces the need for providing an air-tight seal between the movable backstop 307 and a user control (not shown) arranged at the outside of the housing wall 101 to enable the user to control the movable backstop 307. A movable backstop 307 that is controlled by a control unit 411 is preferably arranged in the portion of the earcup 100 that faces the dry side of the displaceable wall 107, such as in the first sub-cavity 108, since this may reduce the need for water-proofing an actuator (not shown) that controls the movable backstop 307. The restriction device 302 may, however, comprise a movable backstop 307 that is manipulatable by the user and is arranged in the portion of the earcup 100 that faces the dry side of the displaceable wall 107 or a movable backstop 307 that is controlled by a control unit 411 and is arranged in the portion of the earcup 100 that faces the wet side of the displaceable wall 107. The restriction device 302 may comprise multiple movable backstops 307 in any combination of the mentioned movable backstops 307.

Any movable backstop 307 may be configured to be controlled to change from it first position to its second position, or vice versa, through a rotary motion, a sliding motion, or any combination hereof.

A restriction device 302 wherein all movable backstops 307 are arranged at the same side of the displaceable wall 107 may require the user to provide a slight over- or under-pressure in one of the first sub-cavity 108 and the second sub-cavity 109 to ensure that the displaceable wall 107 attains its default wall position 303.

In any embodiment, the restriction device 302 may be configured such that the default wall position 303 may be reliably attained and/or maintained when the earcup 100 is in its intended listening orientation but may not necessarily be reliably attained and/or maintained in other orientations. For instance, a vertically arranged and generally disc-shaped displaceable wall 107, such as the one shown in FIGS. 1, 3 and 5, may be easier to urge towards and/or maintain in the default wall position 303 when the earcup 100 is in its intended listening orientation than in another orientation wherein the displaceable wall 107 is horizontally oriented and wherein gravity would therefore urge the displaceable wall 107 downwards.

Any one or more of the flow control device 300, the first valve 301, the restriction device 302, and the movable backstop 307 may comprise a respective user control (not shown) that enables a user of the headset 100 to manipulate the respective device 300, 301, 302, 307 into its respective modes and/or positions. Any such user control may be configured as a rotatable knob, a tiltable lever, a sliding button, a push button, or any other user control known in the art that may provide the required motion of the respective device or of a component thereof. Any user control may be configured to have a bistable operation such that the user control and/or the respective device 300, 301, 302, 307 is unlikely to remain in a mode or position between intended modes or positions when the user fails to complete a motion of the user control. Alternatively, such a user control may be configured to have an operation with more than two stable states.

As shown in FIG. 4, the earcup 100 may comprise a sensor unit 400 with one or more sensors that each provide a respective sensor output signal, such as: a flow control sensor 401 that provides a flow control signal 402 indicating a mode of the flow control device 300; a valve sensor 403 that provides a valve mode signal 404 indicating a mode of the first valve 301; a pressure sensor 405 that provides a pressure signal 406 indicating an estimate of one or more of: the first pressure 113, the second pressure 118, and an ambient pressure 120; a motion sensor 407 that provides a motion signal 408 indicating a motion of the earcup 100; and a wall sensor 409 configured to provide a wall position signal 410 indicating an estimate of one or more of: a position of the displaceable wall 107, a volume of the first sub-cavity 108, and a volume of the second sub-cavity 109.

Each of the flow control sensor 401, the valve sensor 403, and the wall sensor 409 may comprise an optical sensor, a magnetic sensor, a capacitive sensor, or any other known sensor type that can be used to determine the position or proximity of a respective device 300, 301, 107 or a portion thereof relative to another part of the earcup 100.

The wall sensor 409 may alternatively, or additionally, comprise an acoustic sensor, such as an ultrasound sensor that can be used to determine the position or proximity of the displaceable wall 107 or a portion thereof relative to another part of the earcup 100. Alternatively, or additionally, the wall sensor 409 may comprise the electroacoustic transducer 104 and/or another electroacoustic transducer that can be set in motion and monitored to enable the wall sensor 409 to determine the volume of the first sub-cavity 108 and/or the second sub-cavity 109 based on resonances and/or sound reflections occurring in the respective electroacoustic transducer and/or the respective sub-cavity 108, 109. The wall sensor 409 may comprise a microphone for such monitoring and/or comprise a current sensor for determining the electric current through the driver of the respective electroacoustic transducer to enable the wall sensor 409 to determine such resonances and/or sound reflections by analyzing the impedance of the respective electroacoustic transducer.

The pressure sensor 405 may comprise one or more pressure sensors arranged to measure the pressure in respectively the first sub-cavity 108, the second sub-cavity 109, and/or the ambient pressure 120 at the outer side of the housing wall 101. The motion sensor 407 may comprise an accelerometer, a tilt sensor, a vibration sensor, or the like, that enables the motion sensor 407 to detect repetitive movement of the earcup 100.

As also shown in FIG. 4, the earcup 100 may comprise a control unit 411 that receives the one or more sensor output signals 402, 404, 406, 408, 410, analyses the one or more sensor output signals 402, 404, 406, 408, 410 to detect one or more conditions, and provides a condition signal (not shown) indicating the one or more detected conditions.

The one or more conditions may comprise that the earcup 100 is at an excursion to an altitude above ground while at least one of: if present, a flow control device 300 is not in its first mode, and if present, a first valve 301 is not in its second mode. This condition indicates that there may be risk of damage to the earcup 100 and/or the electroacoustic transducer 104 caused by large differences between the first pressure 113, the second pressure 118 and/or the ambient pressure 120.

The one or more conditions may comprise that the earcup 100 is at an excursion to a depth below surface level while at least one of: if present, a flow control device 300 is not in its first mode, and if present, a first valve 301 is not in its second mode. This condition indicates that there may be risk of damage to the earcup 100 and/or the electroacoustic transducer 104 caused by large differences between the first pressure 113, the second pressure 118 and/or the ambient pressure 120, and/or caused by water entering the first sub-cavity 108.

The one or more conditions may comprise that the earcup 100 is at ground level after an excursion to a higher altitude. This condition indicates that the flow control device 300 may safely be controlled into its second mode to increase the noise reduction provided by the earcup 100.

The one or more conditions may comprise that the earcup 100 is at surface level after an excursion to a lower depth. This condition indicates that the flow control device 300 may safely be controlled into its second mode to increase the noise reduction provided by the earcup 100.

The one or more conditions may comprise that the earcup 100 is at ground level or surface level, and one or more of: the first pressure 113 deviates from the second pressure 118 by more than a predefined amount, the position of the displaceable wall 107 deviates from the default wall position 303 by more than a predefined amount, the volume of the first sub-cavity 108 deviates from a default first volume by more than a predefined amount, and the volume of the second sub-cavity 109 deviates from a default second volume by more than a predefined amount. This condition indicates that the first valve 301 may advantageously be controlled into its second mode to relieve an over-or under-pressure in the first sub-cavity 108.

The one or more conditions may comprise that the first pressure 113 deviates from the ambient pressure 120 by more than a predefined amount. This condition indicates that there may be risk of damage to the earcup 100 and/or the electroacoustic transducer 104.

The control unit 411 may determine the presence or absence of one or more sub-conditions based on one or more indications in the one or more sensor output signals 402, 404, 406, 408, 410 and detect the one or more conditions based on the determined presence or absence of the one or more sub-conditions. For instance, the control unit 411 may determine as a sub-condition that the earcup 100 is at an excursion to an altitude above ground when the pressure signal 406 indicates that the first pressure 113, the second pressure 118, and/or the ambient pressure 120 is below a first predefined pressure threshold. Similarly, the control unit 411 may determine as a sub-condition that the earcup 100 is at an excursion to a depth below surface level when the pressure signal 406 indicates that the first pressure 113, the second pressure 118, and/or the ambient pressure 120 is above a second predefined pressure threshold. Furthermore, the control unit 411 may determine as a sub-condition that the earcup 100 is at ground level or surface level when the pressure signal 406 indicates that the first pressure 113, the second pressure 118, and/or the ambient pressure 120 deviates from the nominal atmospheric pressure (1 atm) by less than a predefined amount, and/or when the motion signal 408 indicates that the earcup 100 is moved in a manner consistent with the user of the earcup 100 walking, running or swimming.

The control unit 411 may further provide an acoustic, tactile and/or visual indication to the user in dependence on the one or more detected conditions, and/or control the flow control device 300, the first valve 301, and/or the restriction device 302 in dependence on the one or more detected conditions. For this purpose, the earcup 100 may comprise an indicator 412, such as an LED (not shown) for visual indication, a vibrator (not shown) for tactile indication, and/or a separate electroacoustic transducer (not shown) for acoustic indication. Alternatively, or additionally, the control unit 411 may provide the acoustic indication through the electroacoustic transducer 104.

Such indications may serve to prompt the user to take one or more actions, such as:
manipulating or otherwise controlling the flow control device 300 into its second mode to increase the noise reduction provided by the earcup 100;
manipulating or otherwise controlling the first valve 301 into its second mode to relieve an over- or under-pressure in the first sub-cavity 108;
manipulating or otherwise controlling the flow control device 300 into its first mode to enable a reduction of a pressure difference between the front side 111 and the back side 115 of the diaphragm 105.

The control unit 411 may further be configured to control the restriction device 302 to release the displaceable wall 107 from the default wall position 303 when the condition signal indicates that the first valve 301 is in its first mode and/or to control the restriction device 302 to urge or retain the displaceable wall 107 into/in the default wall position 303 when the condition signal indicates that the first valve 301 is in its second mode. This may enable the user to relieve an over-or under-pressure in the first sub-cavity 108 without having to ensure themselves that the displaceable wall 107 is in or near the default wall position 303.

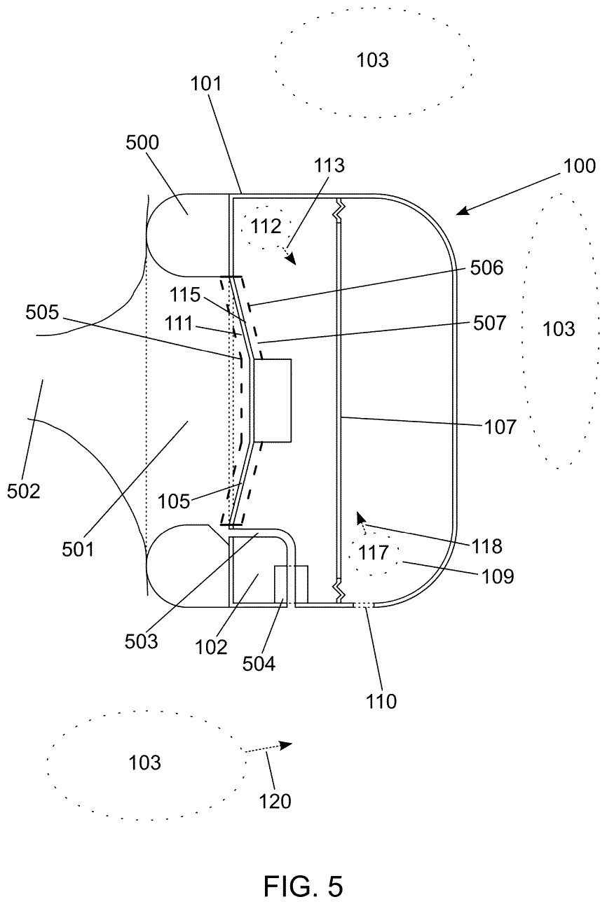

As shown in FIG. 5, the earcup 100 may comprise an annular ear cushion 500 arranged at the outside of the housing wall 101 surrounding the front side 111 of the diaphragm 105 such that when the earcup 100 is worn by a user in an intended listening position at or on one of their ears, the earcup 100, the ear cushion 500, and the user's head delimit a front cavity 501 acoustically coupling the front side 111 of the diaphragm 105 with the ear canal 502 of the respective ear. The ear cushion 500 may thus help reducing the level of noise reaching the user's ear from the surrounding space 103 and at the same time provide a comfortable fit of the earcup 100 against the user's head.

During an increase of the ambient pressure 120, such as during a descent in air or water, the earcup 100 may be pressed against the user's head with an increasing force, and if the ambient pressure 120 is not allowed to propagate into the front cavity 501, then there is a risk that the user's ear and/or the earcup 100 may be damaged. The earcup 100 therefore preferably comprises a vent 503, such as a tube or duct, that fluidly connects the front cavity 501 with the surrounding space 103 when the earcup 100 is worn by the user in the intended listening position. This enables air or water from the surrounding space 103 to enter the front cavity 501 during an increase of the ambient pressure 120 and thus enables an increasing ambient pressure 120 to propagate to the front side 111 of the diaphragm 105. During a decrease of the ambient pressure 120, the earcup 100 will normally be lifted off the user's head so that air or water may escape from the front cavity 501, which normally eliminates the risk of damage in this situation.

To prevent that noise from the surrounding space 103 enters the front cavity 501, the earcup 100 may comprise a second valve 504 that controls fluid flow through the vent 503 such that it enables fluid flow from the surrounding space 103 through the vent 503 into the front cavity 501 only when the ambient pressure 120 exceeds the pressure in the front cavity 501 by more than 1 kPa, more than 2 kPa, or more than 5 kPa. The second valve 504 may alternatively, or additionally, control fluid flow through the vent 503 such that it enables fluid flow from the surrounding space 103 through the vent 503 into the front cavity 501 and prevents fluid flow in the opposite direction, which may further help reducing the level of noise reaching the user's ear from the surrounding space 103.

As also shown in FIG. 5, the earcup 100 may comprise a first cage wall 505 arranged at the front side 111 of the diaphragm 105 and/or a second cage wall 506 arranged at the back side 115 of the diaphragm 105. Each cage wall 505, 506 is configured to restrict movement of the diaphragm 105 and thus protect the diaphragm 105 against damage caused by pressure differences between its front side 111 and its back side 115. Each cage wall 505, 506 further comprises multiple third openings 507 that enable sound waves to pass through the respective cage wall 505, 506, such that they do not unnecessarily restrict the emission of sound into the front cavity 501. Each cage wall 505, 506 may be configured as a mesh wall or as a plate wall with many through holes 507. The one or two cage walls 505, 506 may thus help preventing that the diaphragm 105 is damaged by pressure spikes, e.g. occurring when closing or opening hatches in a pressurized vehicle, and/or when the user or the control unit 411 fails to timely control the flow control device 300 into its first mode at the beginning of a dive or skydive.

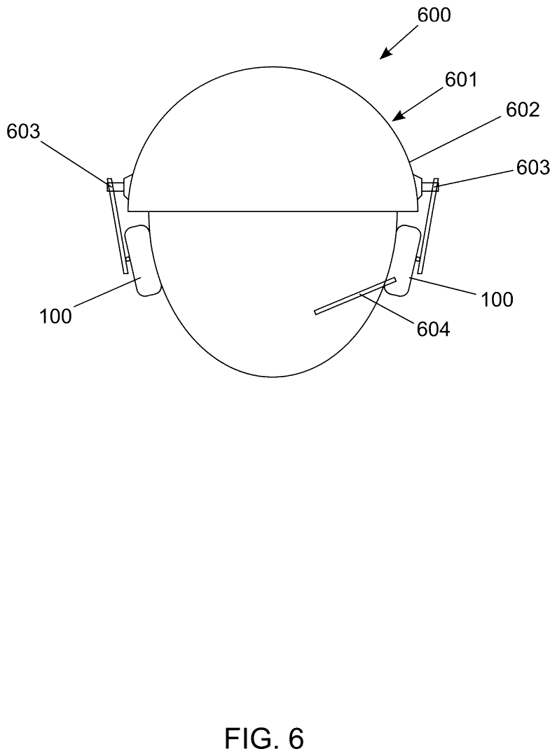

As shown in FIG. 6, one or two earcups 100 may be part of a headset 600 for audio communication. Such a headset 600 may further comprise a headset support structure 601 that enables a user to wear the headset 600 on their head such that for each of the one or two earcups 100 the front side 111 of the respective diaphragm 105 faces a respective ear of the user. The headset support structure 601 may comprise a helmet 602 or other headgear that may be worn during diving or skydiving and/or one or more mechanical connectors 603 for releasably attaching the earcups 100 to the helmet 602, such other headgear, or the headset support structure 601. Alternatively, the headset support structure 601 may comprise a headband (not shown), a neckband (not shown), and/or ear hooks (not shown). The headset 600 may further comprise a microphone arm 604 accommodating a microphone unit (not shown) for picking up the user's speech. The microphone arm 604 may be mechanically attached to one of the one or more earcups 100 and/or to the headset support structure 601, such as to the helmet 602, to one of the one or more mechanical connectors 603, to a headband, a neckband, and/or to an ear hook. Electric and/or optical wiring (not shown) for connecting the one or more earcups 100 with each other and/or with other equipment mounted on the headset support structure 601, such as a camera or a radio, may be routed through and/or along portions of the headset support structure 601.

In any embodiment, the earcup 100 or the headset 600 may comprise electronic components and/or function blocks providing functionality often found in earcups and headsets for audio communication and/or hearing protection. For example, such components and/or function blocks may include one or more microphones and/or vibration sensors for picking up speech of the user, one or more beamformers for spatial filtering of output signals from such microphones to reduce noise, one or more noise suppressors for filtering output signals from such microphones and/or vibration sensors to reduce noise, one or more echo cancellers for filtering output signals from such microphones and/or vibration sensors to reduce echoes from the remote end of an audio communication and/or from the electroacoustic transducer 104, one or more wired or wireless interfaces for receiving audio input signals from other devices and/or for transmitting audio output signals to other devices, one or more connectors, wires, optical conductors and/or cables for such wired interfaces, one or more transmitters, receivers and/or transceivers for such wireless interfaces, one or more amplifiers for amplifying such audio input signals to enable the electroacoustic transducer 104 to emit corresponding sound into a user's ears, and/or one or more adaptive noise cancellers (ANC) for causing the electroacoustic transducer 104 to emit an anti-noise sound that ideally cancels ambient noise that passes through or past the earcup into the user's ear. Such electronic components are preferably arranged in the first sub-cavity 108 to protect them from water during diving. In a headset 600 comprising two earcups 100, those of such electronic components that are only required once may each be selectively arranged at or in only a respective one of the earcups 100, at or in the headset support structure 601, and/or external to the earcups 100 at or in other parts of the headset 600.

Functional blocks of digital circuits may be implemented in hardware, firmware or software, or any combination hereof. Digital circuits may perform the functions of multiple functional blocks in parallel and/or in interleaved sequence, and functional blocks may be distributed in any suitable way among multiple hardware units, such as e.g. signal processors, microcontrollers, and other integrated circuits.

Within this document, the singular forms “a”, “an”, and “the” specify the presence of a respective entity, such as a feature, an operation, an element, or a component, but do not preclude the presence or addition of further entities. Likewise, the words “have”, “include” and “comprise” specify the presence of respective entities, but do not preclude the presence or addition of further entities. The term “and/or” specifies the presence of one or more of the associated entities.

Although particular exemplary hearing devices have been shown and described, it will be understood that it is not intended to limit the claimed inventions to the exemplary hearing devices, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents.

1. An earcup for audio communication comprising:
a housing wall configured to separate an inner cavity inside the earcup from space surrounding the earcup; and
an electroacoustic transducer in a first opening in the housing wall, the electroacoustic transducer having a diaphragm, wherein the diaphragm is configured to be actively driven to emit sound from a front side of the diaphragm, and wherein a first fluid in the inner cavity has a first pressure that exerts a first force on a back side of the diaphragm;
a displaceable wall configured to divide the inner cavity into a first sub-cavity containing the first fluid and a second sub-cavity containing one or more second fluids; and
one or more second openings in the housing wall configured to fluidly connect the second sub-cavity with the space surrounding the earcup;
wherein the displaceable wall is configured to be displaced in correspondence with oppositely directed forces exerted respectively by the first pressure and by a second pressure of the one or more second fluids, and wherein a volume of the first sub-cavity is variable in correspondence to a change in a difference between the first pressure and the second pressure.

2. The earcup according to claim 1, wherein a ratio between a maximum and a minimum volume of the first sub-cavity obtainable by a displacement of the displaceable wall is at least 1.2.

3. The earcup according to claim 1, wherein a ratio between a maximum and a minimum volume of the first sub-cavity obtainable by a displacement of the displaceable wall is at least 1.5.

4. The earcup according to claim 1, wherein a ratio between a maximum and a minimum volume of the first sub-cavity obtainable by a displacement of the displaceable wall is at least 2.

5. The earcup according to claim 1, further comprising a flow control device configured to be controlled into a first mode and a second mode, wherein when the flow control device is in the first mode, it allows flow of the one or more second fluids through the one or more second openings, wherein when the flow control device is in the second mode, the flow control device reduces or prevents the flow of the one or more second fluids through the one or more second openings, at least in a direction into the second sub-cavity.

6. The earcup according to claim 5, wherein the flow control device is selectively controllable by a user of the earcup.

7. The earcup according to claim 5, further comprising a control unit configured to control the flow control device based on a condition signal indicating one or more detected conditions.

8. The earcup according to claim 1, further comprising a first valve configured to be controlled into a first mode and a second mode, wherein when the first valve is in the first mode, the first sub-cavity and the space are fluidly disconnected, and wherein when the first valve is in the second mode, the first sub-cavity and the space are fluidly connected to allow at least a partial equalization of the first pressure and an ambient pressure in the space surrounding the earcup.

9. The earcup according to claim 8, further comprising a control unit configured to control the first valve based on a condition signal indicating one or more detected conditions.

10. The earcup according to claim 8, further comprising:
a vent configured to fluidly connect a front cavity with the space surrounding the earcup when the earcup is worn by a user of the earcup, the front cavity being between the diaphragm and an ear canal of the user; and
a second valve configured to control fluid flow through the vent.

11. The earcup according to claim 10, wherein the second valve is configured to enable fluid flow from the space surrounding the earcup through the vent into the front cavity when the ambient pressure in the space surrounding the earcup exceeds a pressure in the front cavity by more than 1 kPa, more than 2 kPa, or more than 5 kPa.

12. The earcup according to claim 10, wherein the second valve is configured to enable fluid flow in a first direction from the space surrounding the earcup through the vent into the front cavity, and to prevent fluid flow in a second direction opposite the first direction.

13. The earcup according to claim 1, further comprising a restriction device configured to urge the displaceable wall towards a default wall position and/or to restrict the displaceable wall in the default wall position.

14. The earcup according to claim 13, further comprising a control unit configured to control the restriction device based on a condition signal indicating one or more detected conditions.

15. The earcup according to claim 14, wherein the control unit further is configured to control the restriction device to release the displaceable wall from the default wall position when the condition signal indicates that a first valve is in a first mode and/or to control the restriction device to urge or retain the displaceable wall at or towards the default wall position when the condition signal indicates that the first valve is in a second mode.

16. The earcup according to any combination of claims 1, further comprising a sensor unit having one or more sensors, wherein each of the one or more sensors is configured to provide a sensor output signal, wherein the one or more sensors comprise one or more of:
a flow control sensor configured to provide a flow control signal indicating a mode of a flow control device;
a valve sensor configured to provide a valve mode signal indicating a mode of a first valve;
a pressure sensor configured to provide a pressure signal indicating an estimate of one or more of: the first pressure, the second pressure, or an ambient pressure in the space surrounding the earcup;
a motion sensor configured to provide a motion signal indicating a motion of the earcup; or
a wall sensor configured to provide a wall position signal indicating an estimate of one or more of: a position of the displaceable wall, a volume of the first sub-cavity, or a volume of the second sub-cavity.

17. The earcup according to claim 16, further comprising a control unit configured to:
receive the one or more sensor output signals;
analyze the one or more sensor output signals to detect one or more conditions; and
provide a condition signal indicating the one or more detected conditions.

18. The earcup according to claim 17, wherein the control unit is configured to provide an acoustic, tactile and/or visual indication to a user of the earcup based on the condition signal indicating the one or more detected conditions.

19. The earcup according to claim 1, further comprising an ear cushion outside the housing wall surrounding the front side of the diaphragm, wherein when the earcup is worn by a user in an intended listening position at or on an ear of the user, the earcup acoustically couples the front side of the diaphragm with an ear canal of the user.

20. The earcup according to claim 19, further comprising a vent configured to fluidly connect a front cavity with the space surrounding the earcup when the earcup is worn by the user in the intended listening position.

21. The earcup according to claim 1, further comprising a first cage wall, wherein the first cage wall is located closer to the front side of the diaphragm than to the back side of the diaphragm, or is located closer to the back side of the diaphragm than to the front side of the diaphragm, and wherein the first cage wall is configured to prevent excess movement of the diaphragm.

22. The earcup according to claim 21, wherein the first cage wall comprises multiple third openings that allow sound waves to pass through the first cage wall.

23. The earcup according to claim 21, further comprising a second cage wall, wherein the first cage wall is located closer to the front side o the diaphragm than to the back side of the diaphragm, and wherein the second cage wall is located closer to the back side of the diaphragm than to the front side of the diaphragm.

24. The earcup according to claim 1, wherein the displaceable wall is configured to reduce a pressure difference between the front side and the back side of the diaphragm.

25. A headset comprising the earcup according to claim 1, wherein the headset further comprises a headset support structure configured to enable a user to wear the headset on a head of the user such that the front side of the diaphragm of the earcup faces an ear of the user.
